(19) United States
(12) Patent Application Publication
(10) Pub. No.: US 2026/0209092 A1
(43) Pub. Date: Jul. 23, 2026

(54) COMPOSITION COMPRISING CHARGED POLYSACCHARIDE AND COAGULANT, AND METHOD OF USING THE SAME

(71) Applicant: PARAGON SOLUTION INC., Miami, FL (US)

(72) Inventor: Carlos Alberto LOPEZ, Cali (CO)

(21) Appl. No.: 19/140,650

(22) PCT Filed: Dec. 19, 2023
(86) PCT No.: PCT/US2023/084789

§ 371 Date: Jun. 18, 2025

Related U.S. Application Data
(60) Provisional application No. 63/476,010, filed on Dec. 19, 2022.

(51) Int. Cl. C02F 1/56; C02F 1/52; C02F 103/06; C02F 103/08; C02F 103/36

(52) U.S. Cl. CPC C02F 1/56; C02F 1/5245; C02F 2103/06; C02F 2103/08; C02F 2103/365

(57) ABSTRACT

A composition for treating a water-containing solution or mixture is provided. Such a composition includes a charged polysaccharide and a coagulant. The coagulant comprises an aluminum-containing compound. The charged polysaccharide and the coagulant have a ratio by weight in a range of from 1:20 to 20:1. The composition may further comprise water. A method of making and a method of using such a composition are also provided. Such a composition is applied to a solution or mixture comprising water and suspended and/or dissolved substances so as to precipitate the suspended and/or dissolved substances and convert the solution or mixture into clean water.

### PRIORITY CLAIM AND CROSS-REFERENCE

This application claims the benefit of U.S. Provisional Application No. 63/476,010, filed Dec. 19, 2022, which application is expressly incorporated by reference herein in its entirety.

### FIELD OF THE INVENTION

The disclosure relates to water treatment and waste recycling generally. More particularly, the disclosed subject matter relates to a composition and a method of using the same for treating water such as contaminated water, waste water, sea water, sewage, and oil sludge, through flocculation or precipitation of suspended or dissolved impurities.

### BACKGROUND

The removal of suspended matter and dissolved chemicals from water is a concern for municipal water treatment plants, industrial water treatment plants, environmental storm water, recreational water, and oil fields. Such a removal can be useful for recycling chemicals from waste water. Coagulation and flocculation are processes for the removal of suspended matters. Coagulation is initial process of destabilizing or neutralizing charges on suspended particles so that they begin to aggregate. Coagulation is usually combined with flocculation, sedimentation, or filtration. Flocculation is the aggregation of the particles into larger masses. Many chemicals are used for coagulation and/or flocculation. For example, metal salts, such as polyaluminum chlorides, aluminum sulfate, ferric sulfate, and ferric chloride are used. Cationic polymers, such as chitosan, may also be used as coagulants. Chitosan is a polymer derived from naturally occurring chitin.

The drilling of natural gas and oil wells continues to expand throughout the United States. While drilling continues to evolve and change, the one constant is the production of large amounts of contaminated water.

Oil and gas exploration and production result in the extraction of a significant amount of subsurface water, called produced water, along with the hydrocarbon. Formation waters are often produced concurrently with hydrocarbons. Higher amounts of produced water occur during the middle or later stage of the primary production after water breakthrough. A further increase in the amounts of produced water also occurs during the secondary treatment, in which large amounts of external saline water are injected from the surface into the reservoir formation to sustain hydrocarbons production. The amounts of produced waters in some cases could reach 90% or more of the total fluids produced.

The produced water contains contaminants from mineral deposits obtained far beneath the earth's surface. For example, the contaminants may include, but are not limited to, suspended solids and scale forming compounds such as sodium, chloride, iron, calcium, magnesium, barium, strontium and/or residual petroleum hydrocarbons. Oil contains a large number (hundreds) of hydrocarbons. So many hydrocarbons are structurally undetermined or difficult to identify, the de-oiling of produced water is an extensive and expensive process.

Many other industrial processing water and waste water also contain suspended or dissolved substances. Sea water contains a large amount of minerals. Desalination of sea water or distillation are used to make fresh water from sea water.

Using existing coagulation and flocculation processes, only the suspended substances can be precipitated to a certain degree. The dissolved chemicals cannot be removed. To obtain relatively clean water, after a coagulant is used, oxidation using an oxidizing agent such as chlorine dioxide followed by reverse osmosis is needed. The treatment process is time-consuming and also expensive. A quick and cheap treatment process is needed to convert a water solution or mixture containing suspended and/or dissolved chemicals into clean water.

### SUMMARY

The present disclosure provides a composition comprising a charged polysaccharide and a coagulant, a method of making the same, and a method for using the same. Such composition is used to treat a water solution or mixture containing suspended and/or dissolved chemicals and convert it into clean water. Such a method can be used for treating water such as contaminated water, waste water, sea water, sewage, oil sludge, sugar molasses, and any other mixture thereof in need for treatment, through coagulation, flocculation or precipitation of suspended or dissolved impurities.

In accordance with some embodiments, a composition for treating a water-containing solution or mixture is provided. Such a composition comprises a charged polysaccharide and a coagulant. The coagulant comprises an aluminum-containing compound, and the charged polysaccharide and the coagulant have a ratio by weight in a range of from 1:20 to 20:1.

The composition may further comprise water. The charged polysaccharide and the coagulant may be present in a range of from 1% to 30% by weight based on a total weight of the composition, and water may have a content in a range of from 70% to 99% by weight based on the total weight of the composition. For example, in some embodiments, the charged polysaccharide and the coagulant are present in a range of from 1% to 10% by weight based on the total weight of the composition, and water has a content in a range of from 90% to 99% by weight based on the total weight of the composition.

In some embodiments, the aluminum-containing compound is cationic inorganic oligomer or polymer, and the charged polysaccharide is anionic polysaccharide. Examples of the aluminum-containing compound include, but are not limited to, polyaluminum chloride, aluminum chlorohydrate, polyaluminum chlorohydrate, aluminum sulfate, sodium aluminate, polyaluminum sulfate, polyaluminum silicate chloride, polyaluminum silicate sulfate, and any combination thereof. In some embodiments, the aluminum-containing compound is polyaluminum chlorohydrate.

Examples of the charged polysaccharide include, but are not limited to, xanthan gum, polyanionic starch, polyanionic cellulose, and alginate. In some embodiments, the charged polysaccharide is xanthan gum.

In some embodiments, the charged polysaccharide and the coagulant have a ratio by weight in a range of from 1:20 to 20:1, for example, in a range of from 1:5 to 20:1, in a range of from 1:2 to 20:1, in a range of from 1:10 to 10:1, in a range of from 1:8 to 8:1, in a range of from 1:5 to 5:1, or any other ranges.

In some embodiments, the composition further comprises a surfactant and/or an additive. In some other embodiments, the composition does not contain any surfactant or additive. The surfactant or additive may not be needed in some preferred embodiments.

The composition may have a suitable pH value, for example, in an acidic range. In some embodiments, the composition has a pH value in a range of from 3 to 7, for example, from 3 to 6, or from 3 to 5. In some embodiments, the pH is in a range of from about 4 to about 5.

In some embodiments, the composition for treating a water-containing solution or mixture consisting essentially of a charged polysaccharide, a coagulant, and water. The coagulant comprises an aluminum-containing compound, and the charged polysaccharide and the coagulant have a ratio by weight in a range of from 1:20 to 20:1. In some embodiments, the charged polysaccharide and the coagulant have a ratio by weight in a range of from 1:20 to 20:1, for example, in a range of from 1:5 to 20:1, in a range of from 1:2 to 20:1, in a range of from 1:10 to 10:1, in a range of from 1:8 to 8:1, in a range of from 1:5 to 5:1, or any other ranges.

The charged polysaccharide and the coagulant may be present in a range of from 1% to 30% by weight based on a total weight of the composition, and water may have a content in a range of from 70% to 99% by weight based on the total weight of the composition. For example, in some embodiments, the charged polysaccharide and the coagulant are present in a range of from 1% to 10% by weight based on the total weight of the composition, and water has a content in a range of from 90% to 99% by weight based on the total weight of the composition.

In embodiments, the aluminum-containing compound is some polyaluminum chlorohydrate, and the charged polysaccharide is xanthan gum.

In another aspect, a method of making the composition is provided. Such a method comprises at least one step of mixing the charged polysaccharide and the coagulant. Such a method may further comprise dissolving the charged polysaccharide and/or the coagulant in water.

In another aspect, the present disclosure provides a method of using the composition as described herein. The method comprises applying the composition into a solution or mixture comprising water and suspended and/or dissolved substances so as to precipitate the suspended and/or dissolved substances and convert the solution or mixture into clean water. In some embodiments, the aluminum-containing compound is polyaluminum chlorohydrate, and the charged polysaccharide is xanthan gum.

Examples of the solution or mixture to be treatment include, but are not limited to, contaminated water, waste water, sea water, sewage, oil sludge, sugar molasses, and any other mixture thereof in need for treatment.

Such a method may further comprise separating a precipitate comprising the suspended and/or dissolved substances from the solution or mixture. Such separation may include a filtration process. In this process, a step of oxidation or reverse osmosis is not needed to achieve clean water of the same good quality. The composition described herein is able to effectively trap all microscopic particles for easy removal or recovery of by-products. The method is highly efficient, fast and cost-effective.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 (A)-(E) are photos showing jars with (A) Seawater, (B) Seawater with polyaluminum chlorohydrate, (C) Seawater treated with the composition comprising xanthan gum and polyaluminum chlorohydrate (for example, Example 6) (centrifuged, with trapped white impurities at the bottom), (D) Seawater after treated with the composition with trapped impurities removed to provide clear water, and (E) solid impurities removed from seawater.

FIG. 2 (A)-(E) are photos showing the same samples shown in FIGS. 1(A)-(E).

FIG. 3 (A)-(E) are photos showing jars with (A) Leachate, (B) Leachate with polyaluminum chlorohydrate, (C) Leachate treated with the composition comprising xanthan gum and polyaluminum chlorohydrate (for example, Example 6) (centrifuged, with trapped black impurities at the bottom), (D) Leachate after treated with the composition with trapped impurities removed to provide light yellowish water, and (E) solid black-colored impurities removed from leachate. Lab results show that the organoleptic properties that produce the smell in the leachate become neutral in (D).

FIG. 4 (A)-(E) are photos showing the same samples shown in FIGS. 3(A)-(E).

FIG. 5 (A)-(C) are photos showing jars with (A) Hydrocarbon sludge, (B) Hydrocarbon recovered from the hydrocarbon sludge after treatment with the composition comprising xanthan gum and polyaluminum chlorohydrate (for example, Example 6), and (C) solids removed from the petroleum residue after the treatment.

FIG. 6 (A)-(C) are photos showing the same samples of FIGS. 5(A)-(C).

FIG. 7 (A)-(B) are photos showing jars with (A) sugarcane vinasse and (B) solids removed from the sugarcane vinasse after treatment with the composition comprising xanthan gum and polyaluminum chlorohydrate (for example, Example 6).

FIG. 8 (A)-(B) are photos showing the same samples of FIGS. 7(A)-(B).

### DETAILED DESCRIPTION

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. Thus, for example, a reference to “a nano structure” is a reference to one or more of such structures and equivalents thereof known to those skilled in the art, and so forth. When values are expressed as approximations, by use of the antecedent “about,” it will be understood that the particular value forms another embodiment. As used herein, “about X” (where X is a numerical value) preferably refers to +10% of the recited value, inclusive. For example, the phrase “about 8” preferably refers to a value of 7.2 to 8.8, inclusive; as another example, the phrase “about 8%” preferably (but not always) refers to a value of 7.2% to 8.8%, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

Unless expressly indicated otherwise, the term “charged polysaccharide” is understood to encompass any polysaccharides that carry charged groups in the molecules, which include both negatively (acidic polysaccharides) and positively charged polysaccharides. The charged groups help with the solubility of polysaccharides, which is achieved by (1) increasing the molecular affinity to water and (2) preventing the intermolecular association due to the electrostatic effects posed by the charged group. In some embodiments, the charged polysaccharide is a negatively charged polysaccharide, which includes anionic functional groups such as carboxyl groups (—COO⁺) and counterions such as H⁺, Na⁺, or K⁺. In some embodiments, the anionic functional groups are carboxyl groups (—COO⁺), and the counterions are H while the composition is acidic. The charged polysaccharide is water soluble.

The present disclosure provides a composition, a method of making the same, and a method for using the same for treating a water solution or mixture containing suspended and/or dissolved chemicals. After treatment, a clean water having a good quality is obtained.

In accordance with some embodiments, such a composition comprises a charged polysaccharide and a coagulant. The coagulant comprises an aluminum-containing compound. The charged polysaccharide and the coagulant have a ratio by weight in a range of from 1:20 to 20:1. The ratio of the charged polysaccharide and the coagulant is high. The addition of the charged polysaccharide makes the combination comprising the coagulant surprisingly and highly efficient.

The composition may further comprise water. The charged polysaccharide and the coagulant are dissolved or suspended in water. The charged polysaccharide and the coagulant may be present in a range of from 1% to 30% by weight based on a total weight of the composition, and water may have a content in a range of from 70% to 99% by weight based on the total weight of the composition. For example, in some embodiments, the charged polysaccharide and the coagulant are present in a range of from 1% to 10% by weight based on the total weight of the composition, and water has a content in a range of from 90% to 99% by weight based on the total weight of the composition.

In some embodiments, the aluminum-containing compound is cationic inorganic oligomer or polymer, and the charged polysaccharide is anionic polysaccharide. The aluminum-containing compound may include aluminum-containing cations. Each of the two ingredients may contain counterions. The charges in the two ingredients may be also balanced with each other.

Examples of the aluminum-containing compound include, but are not limited to, polyaluminum chloride, aluminum chlorohydrate, polyaluminum chlorohydrate, aluminum sulfate, sodium aluminate, polyaluminum sulfate, polyaluminum silicate chloride, polyaluminum silicate sulfate, and any combination thereof. In some embodiments, the aluminum-containing compound is polyaluminum chlorohydrate.

Examples of the charged polysaccharide include, but are not limited to, xanthan gum, polyanionic starch, polyanionic cellulose, and alginate. In some embodiments, preferably, the charged polysaccharide is xanthan gum.

In some embodiments, an exemplary charged polysaccharide may be other acidic polysaccharides, which are negatively charged. The acidic polysaccharides are not capped with ester groups so that they are charged. Acidic polysaccharides are polysaccharides containing carboxyl groups and/or sulfuric ester groups or sulfated groups. Pectin is a polysaccharide containing the majority of α-(1-4)-linked D-galacturonic acid unit in the backbone and a small percentage of branching portion. The acidic group may be free (or as a simple salt with sodium, potassium, calcium, or ammonium), but not capped with ester groups. Carrageenans are a family of linear sulfated polysaccharides that are extracted from red edible seaweeds with the repeating unit of sulfate esters of 3-β-D-GalP and 3,6-anhydro-α-D-GalP. There are three types of commercial carrageenans including K-carrageenan, λ-carrageenan, and ι-carrageenan, which showed different structural features regarding the number and position of sulfate groups in the repeating unit.

In some embodiments, an exemplary charged polysaccharide may be other acidic polysaccharides, which are positively charged. As one positively charged polysaccharide, chitosan is derived from the deacetylation of chitin. The positively charged groups come from protonation of its free amino groups, which is the key to its water solubility. Chitosan is insoluble in neutral and basic environments due to the lacking of a positive charge. However, in acidic environments, protonation of the amino groups increases the degree of water solubility.

In some embodiments, the charged polysaccharide and the coagulant have a ratio by weight in a range of from 1:20 to 20:1, for example, in a range of from 1:5 to 20:1, in a range of from 1:2 to 20:1, in a range of from 1:10 to 10:1, in a range of from 1:8 to 8:1, in a range of from 1:5 to 5:1, or any other ranges. More preferably, the charged polysaccharide and the coagulant have a ratio by weight in a range of from 1:5 to 5:1, for example, from 1:3 to 5:1, or from 1:2 to 5:1, or from 1:1 to 5:1.

In some embodiments, the composition further comprises a surfactant and/or an additive. In some other embodiments, the composition does not contain any surfactant or additive. A surfactant or addition is not needed.

The composition may have a suitable pH value, for example, in an acidic range. In some embodiments, the composition has a pH value in a range of from 3 to 7, for example, from 3 to 6, or from 3 to 5. In some embodiments, the pH is in a range of from about 4 to about 5, for example, about 4.5.

In some embodiments, the composition for treating a water-containing solution or mixture consisting essentially of (or consisting of) a charged polysaccharide, a coagulant, and water. The coagulant comprises an aluminum-containing compound, and the charged polysaccharide and the coagulant have a ratio by weight in a range of from 1:20 to 20:1. In some embodiments, the charged polysaccharide and the coagulant have a ratio by weight in a range of from 1:20 to 20:1, for example, in a range of from 1:5 to 20:1, in a range of from 1:2 to 20:1, in a range of from 1:10 to 10:1, in a range of from 1:8 to 8:1, in a range of from 1:5 to 5:1, or any other ranges as described above.

The charged polysaccharide and the coagulant may be present in a range of from 1% to 30% by weight based on a total weight of the composition, and water may have a content in a range of from 70% to 99% by weight based on the total weight of the composition. For example, in some embodiments, the charged polysaccharide and the coagulant are present in a range of from 1% to 10% by weight based on the total weight of the composition, and water has a content in a range of from 90% to 99% by weight based on the total weight of the composition.

In embodiments, the aluminum-containing compound some is polyaluminum chlorohydrate, and the charged polysaccharide is xanthan gum.

In another aspect, a method of making the composition is provided. Such a method comprises at least one step of mixing the charged polysaccharide and the coagulant, in the ratio or amounts needed. Such a method may further comprise dissolving the charged polysaccharide and/or the coagulant in water.

In another aspect, the present disclosure provides a method of using the composition as described herein. The method comprises applying the composition into a solution or mixture comprising water and suspended and/or dissolved substances so as to precipitate the suspended and/or dissolved substances and convert the solution or mixture into clean water. In some embodiments, the aluminum-containing compound is polyaluminum chlorohydrate, and the charged polysaccharide is xanthan gum.

Examples of the solution or mixture to be treatment include, but are not limited to, contaminated water, waste water, sea water, sewage, oil sludge, sugar molasses, and any other mixture thereof in need for treatment.

Such a method may further comprise separating a precipitate comprising the suspended and/or dissolved substances from the solution or mixture. Such separation may include a centrifuging process and a filtration process. In this process, a step of oxidation or reverse osmosis may not be needed to achieve clean water of the same good quality. The method is highly efficient, fast and cost-effective.

An exemplary embodiment of the water treatment composition comprises or consists essentially of xanthan gum and polyaluminum chlorohydrate.

As shown in Scheme (1), xanthan gum is a polysaccharide that comprises of pentasaccharide repeat units, including glucose, mannose, and glucuronic acid in the molar ratio 2:2:1. The glucuronic and pyruvic acid groups, which comprise carboxyl acid group, give xanthan gum a highly negative charge under a suitable condition. The presence of anionic side chains on the xanthan gum molecules enhances hydration and xanthan gum soluble in cold as well as hot water.

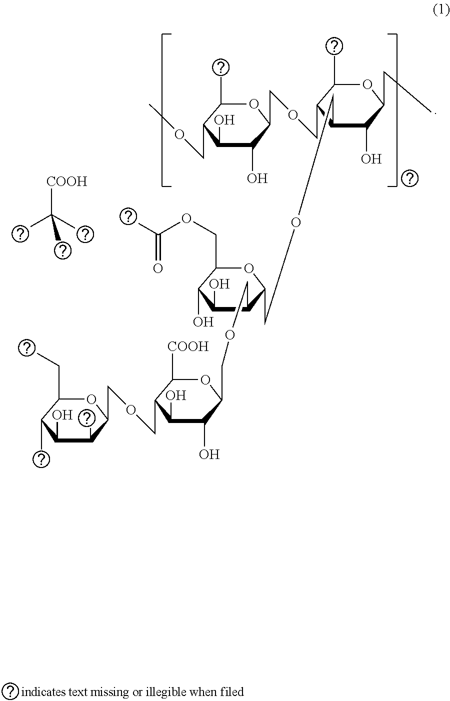

Xanthan gum is a polysaccharide with many industrial uses, including as a common food additive. It is an effective thickening agent, emulsifier, and stabilizer that prevents ingredients from separating. It can be produced from simple sugars using a fermentation process and derives its name from the species of bacteria used, Xanthomonas campestris. Compared to its use as emulsifier and stabilizer, xanthan gum in the composition of the present disclosure surprisingly provides or helps with precipitation function.

As a comparison, some polysaccharides such as guar are non-charged. Guar gum contains galactose and mannose sugars, and do not have any ionic functional group. Sometimes, a polysaccharide, which may be charged, may be chemically modified to become non-charged polysaccharide. For example, a polysaccharide having carboxyl groups can be capped with ester groups, and become non-charged. In the present disclosure, a charged polysaccharide is preferred and provides surprisingly good results. A charged polysaccharide, particularly negatively charged polysaccharide (anionic polysaccharide) is more preferred. Such a charged polysaccharide comprises carboxyl group in some embodiments. The charged polysaccharide is water-soluble. The charged polysaccharide such as xanthan gum may have a suitable molecular weight, for example, in a range of from 0.5×10⁶ to 10×10⁶. The molecular weight values may be based on weight averaged molecular weight (Mw) tested based on gel permeation chromatography (GPC).

Aluminum hydroxychloride is a basic salt of aluminum chloride, and an oligomer or polymer of aluminum hydroxychloride has a formula: Alₙ(OH)ₘCl₍₃ₙ₋ₘ₎·H₂O, where 0<m<3n. It is essentially a cationic inorganic polymer. In some embodiments, aluminum hydroxychloride has a formula of [AlO₄Al₁₂(OH)₂₄. (H₂O)₁₂]⁷⁺. The positive charges may be balanced with counterions and/or negative charges from the charged polysaccharide.

### EXAMPLES

In accordance with some embodiments, a composition provided in the present disclosure includes xanthan gum as a first component (i.e., component A), polyaluminum chlorohydrate as the second component (i.e., component B″), and water. The aluminum-containing compound used is polyaluminum chlorohydrate, and the charged polysaccharide used is xanthan gum. A series of inventive compositions were made. The examples includes Experimental Examples from Example 1 (“Ext. 1”) to Example 12 (“Ext. 12”) are shown in Tables 1 and 2. The content of water is optional and can be adjusted. So the compositions can be in a dry solid form or in a solution. In the examples as shown in Tables 1 and 2, 700 mL (i.e., 700 grams) water was used. Comparative examples such as Comparative Example 1 (“CEx. 1”) and Comparative Example 2 (“CEx. 2”) contain xanthan gum or polyaluminum chlorohydrate only. Polyaluminum chlorohydrate only is currently used in industry.

TABLE 1

| | CEx. 1 | CEx. 1 | Ex. 1 | Ex. 2 | Ex. 3 | Ex. 4 | Ex. 5 | Ex. 6 |
|---|---|---|---|---|---|---|---|---|
| Xanthan Gum | 0 | 50 | 2 | 5 | 10 | 14 | 20 | 50 |
| (A, g) | | | | | | | | |
| Polyaluminum | 14 | 0 | 14 | 14 | 14 | 14 | 14 | 14 |
| chlorohydrate | | | | | | | | |
| (B, g) | | | | | | | | |
| Water (g) | 700 | 700 | 700 | 700 | 700 | 700 | 700 | 700 |
| A/B ratio (1:_) | | | 7 | 2.8 | 1.4 | 1.00 | 0.7 | 0.28 |
| A/B ratio (_:1) | | | 0.14 | 0.36 | 0.71 | 1.00 | 1.43 | 3.57 |
| A:B (by | | | 1:7 | 1:2.8 | 1:1.4 | 1:1 | 1.43:1 | 3.57:1 |
| weight) | | | | | | | | |
| Xanthan Gum | 0.00% | 6.67% | 0.28% | 0.70% | 1.38% | 1.92% | 2.72% | 6.54% |
| (A, Wt. %) | | | | | | | | |
| Polyaluminum | 1.96% | 0.00% | 1.96% | 1.95% | 1.93% | 1.92% | 1.91% | 1.83% |
| chlorohydrate | | | | | | | | |
| (B, wt. %) | | | | | | | | |
| Water (wt. %) | 98.04% | 93.33% | 97.77% | 97.36% | 96.69% | 96.15% | 95.37% | 91.62% |

TABLE 2

| | Ex. 6 | Ex. 7 | Ex. 8 | Ex. 9 | Ex. 10 | Ex. 11 | Ex. 12 |
|---|---|---|---|---|---|---|---|
| Xanthan Gum (A, g) | 50 | 5 | 10 | 15 | 35 | 40 | 45 |
| Polyaluminum | 14 | 12.6 | 11.2 | 9.8 | 4.2 | 2.8 | 1.4 |
| chlorohydrate (B, g) | | | | | | | |
| Water (g) | 700 | 700 | 700 | 700 | 700 | 700 | 700 |
| A/B ratio (1:_) | 0.28 | 2.52 | 1.12 | 0.65 | 0.12 | 0.07 | 0.03 |
| A/B ratio (_:1) | 3.57 | 0.40 | 0.89 | 1.53 | 8.33 | 14.29 | 32.14 |
| A:B (by weight) | 3.57:1 | 1:2.52 | 1:1.12 | 1.53:1 | 8.33:1 | 14.29:1 | 32.14:1 |
| Xanthan Gum (A, | 6.54% | 0.70% | 1.39% | 2.07% | 4.73% | 5.39% | 6.03% |
| Wt. %) | | | | | | | |
| Polyaluminum | 1.83% | 1.76% | 1.55% | 1.35% | 0.57% | 0.38% | 0.19% |
| chlorohydrate (B, wt. %) | | | | | | | |
| Water (wt. %) | 91.62% | 97.55% | 97.06% | 96.58% | 94.70% | 94.24% | 93.78% |

Comparative Example 1 (“CEx. 1”) and Comparative Example 2 (“CEx. 2”), which contain xanthan gum or polyaluminum chlorohydrate only, do not work well for the applications in the present disclosure based on the inventor's trials.

The experimental samples such as Example 6 was used for treatment in some experiments including large-scale experimental trials on different sites. The ratio of Component A (xanthan gum) to Component B (polyaluminum chlorohydrate) needs to be in a suitable range. More concentration of xanthan gum will make the solution thicker and will make it difficult to work with. A thicker solution will make it difficult to run smoothly through pipelines. On the other hand, adding more or less concentrations of polyaluminum chlorohydrate may not make a difference. Xanthan gum enhances the performance of the compositions containing polyaluminum chlorohydrate, and provides surprisingly synergetic effects.

Based on the numerous trials, xanthan gum and polyaluminum chlorohydrate may have a suitable ratio by weight in a range of from 1:20 to 20:1, for example, in a range of from 1:5 to 20:1, in a range of from 1:2 to 20:1, in a range of from 1:10 to 10:1, or in a range of from 1:8 to 8:1. More preferably, xanthan gum and polyaluminum chlorohydrate has a ratio in a range of from 1:5 to 5:1, for example, from 1:2 to 5:1. Examples 2-9 have a ratio in such ranges. For example, Example 6 and other similar formulations exhibited complete homogeneity, and very efficient decantation in the treatment processes.

Referring to Table 1, Example 1 with a higher amount of polyaluminum chlorohydrate tended to have a low efficiency for treatment indicated by a slow decantation in the water or mixture treated. A slow decantation was observed in Example 7, which has a ratio of xanthan gum to polyaluminum chlorohydrate close to 1:2.52. A slow decantation is not desired in treatment.

Referring to Table 2, Examples 10 and 11 have a ratio of xanthan gum to polyaluminum chlorohydrate higher than 8:1, and this higher level of xanthan gum will make the solution thicker, and oversaturated while a trace amount of gelation was observed. Example 12 with even higher amount of xanthan gum was also oversaturated and a significant amount of gelation was observed. The oversaturation or thickening make these formulations less desirable for some treatment applications.

The composition may have a suitable pH value, for example, in an acidic range. In some embodiments, the composition has a pH value in a range of from 3 to 7, for example, from 3 to 6, or from 3 to 5. In some embodiments, the pH is in a range of from about 4 to about 5, for example, about 4.5 in the Examples such as Example 6. The amount of water may affect the pH value. Other pH levels do not affect the effectiveness of the inventive composition.

The composition has excellent stability, and can last effectively for more than at least a year and a half based on the experiments. In some embodiments, no surfactant, stabilizer, or preservative is added.

A suitable amount of an experimental sample can be used, depending on the type of the water or other materials to be treated. The ratio of an experimental sample such as Example 6 used to the water or other materials to be treated may be in a range from about 1:5 to about 1:2,500 by weight. In some embodiments, such a ratio is in a range of from about 1:10 to 1:500, or from about 1:10 to about 1:200, or from about 1:10 to about 1:100. For example, a ratio of 1:100, 1:200, 1:50, 1:20, or any other suitable ratio can be used. These values are also applicable if the ratio is by volume considering similar densities. For a specific waste water or solution to be treated, such a ratio can be adjusted to achieve the best results.

The efficiency of these composition varies if the concentrations of its components are changed.

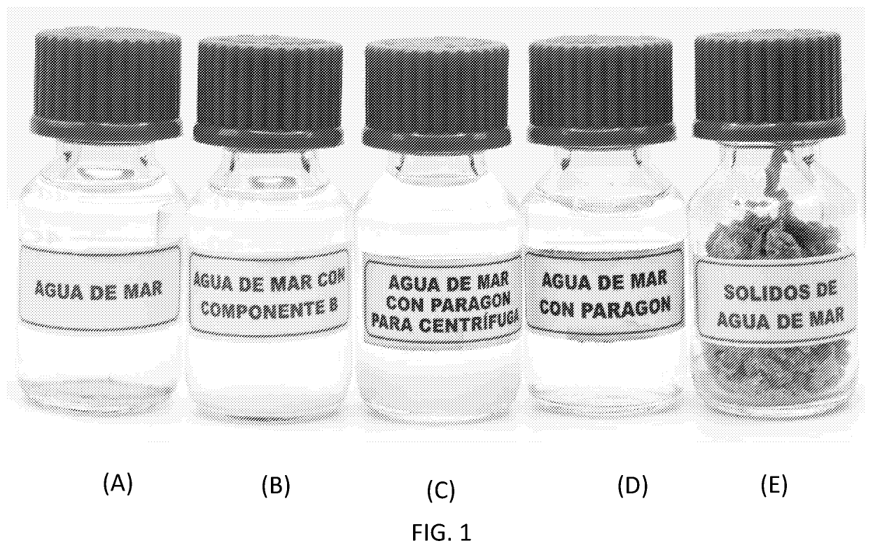

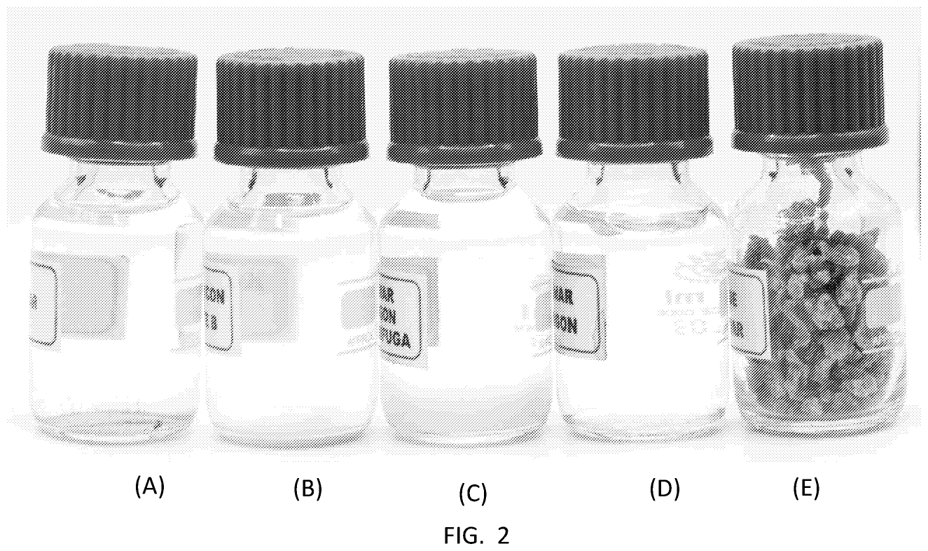

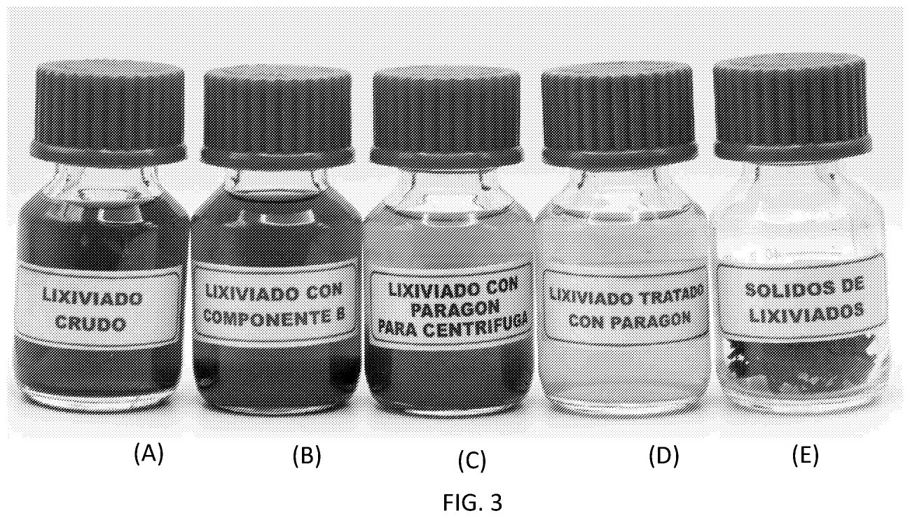

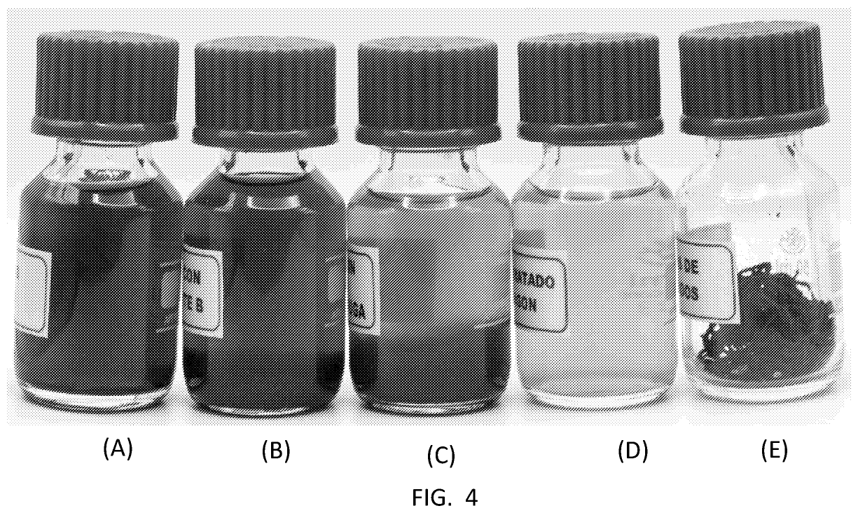

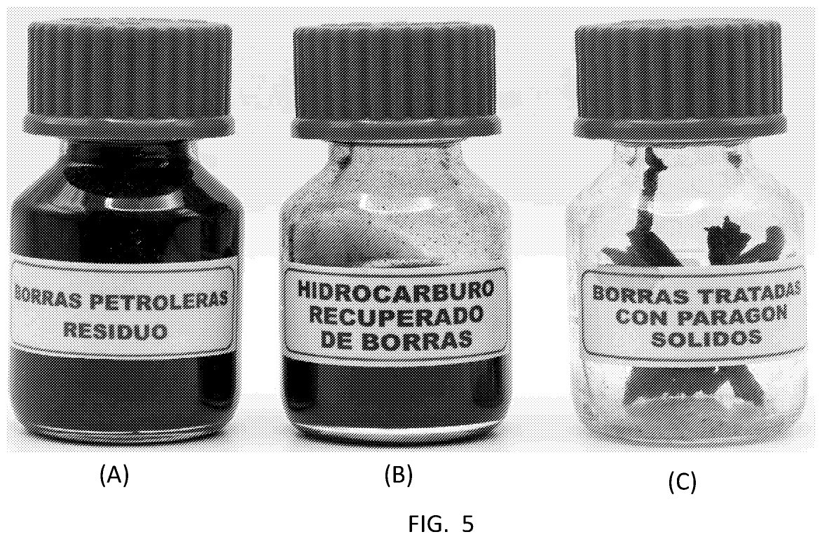

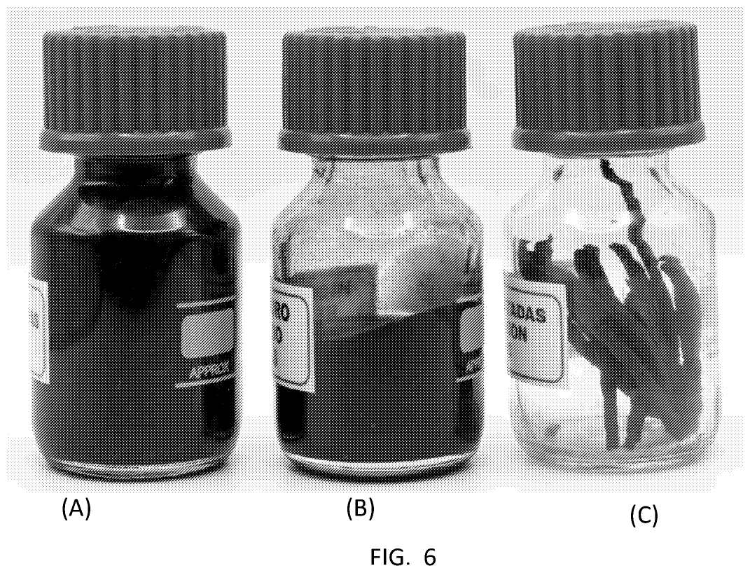

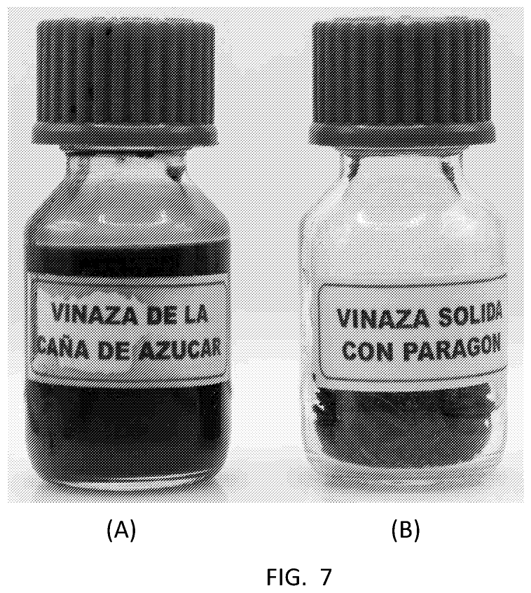

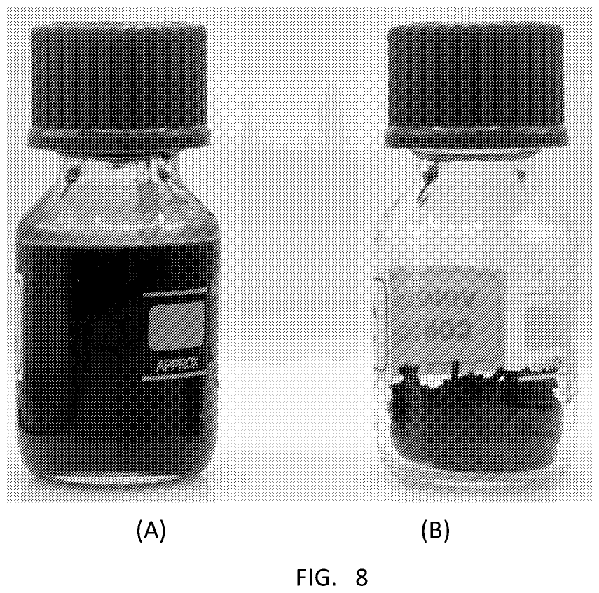

Using the experimental examples, treatment tests with leachates, seawater, oil sludge, swimming pool water, and sugarcane vinasse were performed, respectively. The compositions showed excellent efficacy. The results can be easily seen in FIGS. 1-8. The treatment tests were also performed with oil water, reverse osmosis reject water, mine waste water with cyanide, and water with fat from meat plants, respectively.

The samples before and after treatment were tested using standard testing methods as follows. For examples, the metal ions were measured using the flame atomic absorption method. ASTM D4294 is the test standard used for measuring total sulfur content in petroleum products using X-ray fluorescence, and is suitable for liquids and liquefiable or soluble hydrocarbons. ASTM D473 is the test standard used for determining sediment levels in crude oils and fuel oils using toluene extraction. Such a test is applicable for sediment concentrations from 0.01% to 0.40%. ASTM D4530 is the test standard used for evaluating the carbon residue left after petroleum materials evaporate and undergo pyrolysis, indicating the tendency for coke formation.

SM 2320 B is the test standard for alkalinity test that measured the capacity of a water sample to neutralize acids. This is an important parameter for understanding the buffering capacity of a sample such as leachate or sea water. Following standard method SM 5220 D, a modified test was used for testing chemical oxygen demand (COD), which measures the amount of organic compounds in leachate. This modified version was tailored for specific types of samples or regulatory requirements. SM 5520 D is the standard method used for testing solvent extractable materials, which quantifies the amount of non-volatile or semi-volatile compounds extractable from leachate by a solvent. SM 4500-NH₃ B, C is the standard method for ammonia test that measures the concentration of ammonia in leachate, and includes both manual (B) and automated colorimetric (C) methods. SM 2540 D is the standard method for total suspended solids (TSS) test, which measures the suspended solids in a sample such as leachate or sea water, an important indicator of water quality and clarity. SM 2130 B is the standard method for turbidity test that measures the clarity of a sample such as leachate or sea water by assessing the amount of light scattered by particles in the water. SM 9223 B is the standard method for detecting and enumerating coliform bacteria using the enzyme substrate method. It is important for assessing the microbiological quality of leachate. SM 9221 E is the standard method for detection of total coliforms and E. coli specifically in water and wastewater using a multiple-tube fermentation technique.

SM 2510 B is the standard method for measuring the concentration of specific conductance in water, which is indicator of the amount of dissolved salts or ionic substances in a sample such as a concentrated leachate or sea water.

In the experiments described herein, sometimes polyaluminum chlorohydrate is described by volume, and it may contain a small amount of water. The volume can be converted into weight, by a factor of 15 mL of polyaluminum chlorohydrate equivalent to 14 g of polyaluminum chlorohydrate.

The ionic content of the fluid to be treated was known in the laboratory before and after treatment with the Experimental Samples such as Example 6. The experimental samples such as Example 6 is also called Paragon. For the leachates, according to the samples sent, a pH of 7.5 was set and it did not change after the experimental compositions were added.

### 1. Testing Results of Comparative Examples

Polyaluminum chlorohydrate has been used in the existing treatments, and is described herein as Comparative Examples. The treatment process using polyaluminum chlorohydrate is complex, costly, and time-consuming. To obtain relatively clean water, after a coagulant is used, oxidation using an oxidizing agent such as chlorine dioxide followed by reverse osmosis is needed.

### 1.1. Treatment of Leachates Using Polyaluminum Chlorohydrate as the Comparative Example

A leachate monitoring program was developed in the Yotoco landfill in Valle Del Cauca, Colombia. Three leachate specimens for each sample were taken for lab analysis. The samples included a raw leachate sample, the leachate treated in a test system using polyaluminum chlorohydrate, the leachate treated and added chlorine dioxide, and the leachate sample further treated with reverse osmosis. Three liquid samples of 4.0 liters were collected each for lab analysis. The treatment rest on site was made on 6,000 liters using 2 gallons of polyaluminum chlorohydrate.

A Leachate sample was collected for the test. Polyaluminum chlorohydrate was applied and left to act for the next two hours. Water was put through a mesh filter and then to reverse osmosis to be able to obtain the report results.

The testing results are summarized in Table 3.

TABLE 3

| | | After treated with | After further | After |
|---|---|---|---|---|
| | | Polyaluminum | treated with | reverse |
| Parameters | Leachate | chlorohydrate | ClO₂ | osmosis |
| pH | 7.5 | 7.2 | 6.8 | |
| Alkalinity total | 14,226.9 | 16.5 | 19.5 | 16.5 |
| (mg CaCO₃/L) | | | | |
| Chlorides | 2,606.5 | <1.00 | 7.7 | <1.0 |
| (mg/L) | | | | |
| Nitrates | 0.220 | <0.02 | <0.02 | <0.02 |
| (mg/L) | | | | |
| Ammoniacal | 1,034.8 | 2.0 | 7.0 | 2.0 |
| Nitrogen (mg/L) | | | | |
| Sulfates (mg/L) | 6,750.2 | 11.9 | 11.5 | 11.9 |
| DBO5 (mg O₂/L) | 2,150 | 6.36 | 4.64 | 6.4 |
| Oxygen dissolved | | | | |
| in the water | | | | |
| DQO (mg O₂/L) | 7,535 | 41.7 | 41.7 | 41.7 |
| Hardness, as | 870.3 | 2.14 | 1.9 | 2.1 |
| CaCO₃ (mg/L) | | | | |
| Total Suspended | 580 | <10.9 | <10.9 | <10.9 |
| Solids (mg/L) | | | | |
| Copper (mg/L) | 1.81 | 0.03 | 0.02 | 0.03 |
| Mercury (mg/L) | 0.002 | <0.001 | <0.001 | <0.001 |
| Total Coliforms | >1,600 | 0 | 0 | 0 |
| (Bacteria) | | | | |
| Fecal Coliforms | 240 | 0 | 0 | 0 |
| (Fecal Contamination) | | | | |

### 1.2. Treatment of Oil Exploration Well Water Using Polyaluminum Chlorohydrate as the Comparative Example for Water Reuse

For a sample of raw water, which was treated in a treatment system to improve its condition and lower the concentration of contaminants, three specimens were taken, including one at the beginning, one intermediate, and one at the end of the process for characterization. In total, about three cubic meters were processed, of which they were pumped to the flocculent treatment tank.

On site test lasted for 90 days on the oil exploration well camp site. Water from river sources was received daily in water trucks to provide water for camp, bathrooms, and drilling mud. The water from natural sources such as rivers is used for preparation of muds with chemicals for oil drilling, or treated for oil well uses. The used water is then reused.

More than 40 water trucks were treated with polyaluminum chlorohydrate. The water tanks carried the raw water to the camp for drilling, bathrooms, and other uses. The dirt was removed, and solids from the water to be recycled. Polyaluminum chlorohydrate was applied and then reverse osmosis was used to remove metal ions.

The results are shown in Table 4.

TABLE 4

| | | After treated with | After |
|---|---|---|---|
| | Initial | Polyaluminum | reverse |
| Parameters | water | chlorohydrate | osmosis |
| Solid total | 1,015.0 | 2,890.0 | 34.0 |
| (mg/L) | | | |
| Alkalinity total | 18.2 | <0.56 | 21.4 |
| (mg CaCO₃/L) | | | |
| Chlorides | 55.3 | 272.4 | 5.0 |
| (mg/L) | | | |
| Total | 75.6 | 25.2 | 6.30 |
| Hydrocarbons | | | |
| DBO5 (mg O₂/L) | 315 | 294.6 | 60.6 |
| DQO (mg O₂/L) | 1,010.88 | 1,381.54 | 64.02 |
| Hardness, as | 171.91 | 4.25 | 4.25 |
| CaCO₃ (mg/L) | | | |
| Calcium | 157.34 | 262.1 | 4.01 |
| Hardness (mg/L) | | | |
| Sulfates (mg/L) | 125.9 | 1,550.3 | 5.6 |
| Fats and Oils | 67.72 | 9.3 | <5 |
| (mg/L) | | | |
| Total Phenols | 0.11 | 0.31 | 0.06 |
| (mg/L) | | | |
| Nickel (mg/L) | 0.028 | <0.016 | <0.016 |
| Calcium (mg/L) | 63.01 | 1.60 | 1.60 |

The variation in the value of the total solids of the untreated water to that treated with polyaluminum chlorohydrate only is due to a process of increasing the molecular weight of the dissolved microparticles in treated water. Polyaluminum chlorohydrate binds the dissolved particles, turning them into particles, providing particles larger in size, therefore increasing the molecular weight of the particle. This cause causes the particles to be considered as a dissolved solid. As dissolved solids increase, total solids increase. For the same reason, the variation in sulfates (mg/L) is provided.

### 1.3. Treatment of Sea Water Using Polyaluminum Chlorohydrate Only

Seawater was collected from the open sea of the Pacific Ocean near Buenaventura, Colombia. 20 gallons of seawater were used for the tests with 1 liter of polyaluminum chlorohydrate solution. The seawater was left to act for three hours.

The removal process is described here as follows. This removal process is also applicable when the inventive compositions are used.

The solution or gel comprising polyaluminum chlorohydrate separates and then traps contaminates from solutions, which causes them to sink. So the minerals, hydrocarbons, ashes, or other substances are separated from sea water. Once contaminates are removed, the remaining water can be processed, via, for example, reverse osmosis to create drinkable water. The contaminate removal is helpful because it avoids damaging treatment systems (e.g., reverse osmosis).

The solution comprising polyaluminum chlorohydrate can also be in a gel or powder form. The powder form can be added to the separated contaminates to solidify them to be rock-like solid. For example, the hydrocarbons become just carbon.

The results are shown in Table 5.

TABLE 5

| | Initial | After treated with | After |
|---|---|---|---|
| | sea | Polyaluminum | reverse |
| Parameters | water | chlorohydrate | osmosis |
| pH | 7.65 | 4.5 | 3.6 |
| Oxygen | 6.7 | 5.9 | 7.5 |
| (mg/L) | | | |
| Nitrogen total | <1.5 | 3.28 | 1.79 |
| (mg /L) | | | |
| Ammoniacal | <1.5 | <0.28 | <0.28 |
| nitrogen | | | |
| (mg/L) | | | |
| Hydrocarbons | <0.01 | <0.01 | <0.01 |
| total (mg/L) | | | |
| Cr | <0.025 | 0.024 | 0.007 |
| (mg/L) | | | |
| Cd | <0.033 | 0.0007 | 0.0003 |
| (mg/L) | | | |
| Mg | 559 | 320 | 1.87 |
| (mg/L) | | | |
| Ca | 211 | 172.3 | 1.92 |
| (mg/L) | | | |
| Ag | <0.038 | 0.0004 | 0.0004 |
| (mg/L) | | | |
| Pb | <0.21 | <0.0026 | 0.12 |
| (mg/L) | | | |
| Zn | <0.04 | 0.84 | <0.04 |
| (mg/L) | | | |
| Total Phenols | <0.001 | 0.0055 | 0.128 |
| (mg/L) | | | |
| DBO5 | 62.4 | 83.8 | 10.4 |
| (mgO₂/L) | | | |
| DQO | 26.0 | 272 | 108.8 |
| (mgO₂/L) | | | |
| Total | 37 | 580 | 30 |
| Suspended | | | |
| Solids | | | |
| (mg/L) | | | |
| Turbidity | 19.2 | 311 | 0.40 |
| (NTU) | | | |
| Salinity (ppt) | 15.7 | 14.1 | 1.2 |
| Fats and Oils | 202.4 | 93.3 | 65.1 |
| (mg/L) | | | |

### 2. Testing Results of Experimental Examples

Experiments were conducted to demonstrate the effectiveness of Example 6 in grouping contaminant particles in leachate, hydrocarbon sludge, oil water, and seawater compared to the existing composition or comparative example, which is polyaluminum chlorohydrate only. All the experiments described herein are experimental trials no matter how much water was treated.

### 2.1. Oil Plant Waste Water Treatment

Water treatment with experimental composition such as Example 6 was done first in a lab, and an experimental trial as a larger scale test was made on a campsite. For 100 barrels of water used in the oil extraction process, 30 liters of Example 6 were added and then agitated for 15 minutes and then left to act for the next for 24 hours. After 24 hours, water was transparent and all residue was trapped on the bottom. One barrel in the present disclosure is about 159 liters.

### 2.2. Hydrocarbon Sludge Treatment

Several 1-liter sample trials were made with 10 ml to 50 ml of Example 6. Then a large-scale experimental trial was performed. 500 barrels of hydrocarbon sludge were removed from the company storage pools via a vactor to a storage tank. 120 liters of Example 6 solution were added. The vactor stirred and mixed the solution for half an hour and was left to act for the following 24 hours. After 24 hours, three visible layers were easily seen, oil, water, and solids. Treated hydrocarbon sludge was moved to a heat tank via vactor, which was a truck for heavy crudes. Conventional centrifuge was used to separate solids and recover oil and water.

In another experiment, 50 barrels of hydrocarbon sludge were used in the trial with 30 liters of Example 6 in a heat tank. The solution was left to act for three hours. Tricanter centrifuge was used to separate solids, water, and crude. Petcoke was recovered from the solids. One objective was for no residue to be left unused.

### 2.3. Crude Oil Treatment

Residue of crude that is rejected by the refinery was used on an experimental trial. The crude oil was rejected since it is too dirty, and had too many solids, therefore becomes more expensive to treat.

One objective was to treat the crude oil with the inventive composition such as Example 6 so as to reduce sulfur and carbon levels and the content of the solids. 10 gallons of crude oil were used in the test with 1 liter of Example 6, and was left to act in a heat tank for the following three hours. Samples were taken to a centrifuge. Separated water, crude, and solids were obtained.

### 2.4. Treatment of Leachates Using Example 6

Similar to what is described above, leachate samples were treated with Example 6. The testing results are summarized in Table 6.

TABLE 6

| | | Treated with | Treated |
|---|---|---|---|
| | | Polyaluminum | with |
| Parameters | Leachate | chlorohydrate | Example 6 |
| pH | 7.51 | 7.10 | 7.64 |
| Alkalinity total | 10,624 | 9,398 | 7,049 |
| (mg CaCO₃/L) | | | |
| Chlorides | 1,808 | 1,969 | 2,329 |
| (mg/L) | | | |
| Nitrates | 19.29 | 23.97 | 12.13 |
| (mg/L) | | | |
| DQO (mgO₂/L) | 5,564 | 3,964 | 3,152 |
| DBO5 | 728 | 536 | 423 |
| (mgO₂/L) | | | |
| Ammoniacal | 1,747.48 | 2,263.52 | 1544.20 |
| nitrogen (mg/L) | | | |
| Total Suspended | 120 | 140 | 48 |
| Solids | | | |
| (mg/L) | | | |
| Nitrites (mg/L) | 0.140 | 0.100 | 0.045 |
| Turbidity | 160 | 160 | 45 |
| (NTU) | | | |
| Cu (mg/L) | <0.100 | <0.100 | <0.100 |
| Mg (mg/L) | 324 | 153 | 191 |
| Cr (mg/L) | <0.100 | <0.100 | <0.100 |
| Hg (mg/L) | <0.100 | <0.100 | <0.100 |
| Pb (mg/L) | 0.199 | 0.143 | 0.139 |
| Total Coliforms | 3,000 | 457,000 | 2,000 |
| (Bacteria) | | | |
| (NMP/100 mL) | | | |
| Fecal Coliforms | >1,600 | >160,000 | 1,600 |
| (Fecal | | | |
| Contamination) | | | |
| NMP/100 mL | | | |
| Fats and Oils | 107 | 40.0 | <8.24 |
| (mg/L) | | | |

A large number of compounds are dissolved in the leachates, and their chemical formula may contain nitrogen, urea, ammonia, and other nitrogen-containing species. When polyaluminum chlorohydrate only is used, it helps the nitrogen-containing species to appear through a physicochemical process that consists of extracting nitrogen and urea from said substances that can be transformed in ammoniacal nitrogen, so the values of this compound increase in leachates after treated with polyaluminum chlorohydrate only. With the inventive compounds such as Example 6 is used, it captures all the ammoniacal nitrogen, generating a fact that leads to the values decreasing.

For fecal coliforms (NMP/100 mL) as shown in Table 6, when polyaluminum chlorohydrate only is used, it can be converted into a nutritional substance that allows the multiplication of existing fecal coliforms. These are living organisms, therefore, when they find nutritive substances, their presence in the leachate increases. When a charged polysaccharide is used (i.e., when the inventive compound is used), the measurement comes close to the measurement of the untreated leachate. This fact allows us to conclude that the inventive compound is bactericidal.

Based on the results in Table 6, polyaluminum chlorohydrate decreases the alkalinity of the leachate, and the inventive compound in the leachate removes a greater amount of ions present, therefore reducing the alkalinity. The inventive compound decreases the amount of dissolved oxygen that the leachate can obtain as DBO5, decreasing the leachate contamination index, that is, it initiates a leachate purification process. Polyaluminum chlorohydrate, when used alone, decreases the DQO, while the inventive compound decreases it more. This indicates that the inventive compound helps in the treatment of wastewater that requires less oxygen in its purification process. Polyaluminum chlorohydrate does not change the salinity in its withdrawal from the leachate, while the inventive compound reduces it by 20%.

### 2.5. Treatment of Sea Water

Seawater was collected from the open sea of the Pacific Ocean near Buenaventura, Colombia. 20 gallons of seawater were used for the tests with 1 liter of Example 6. The seawater was left to act for three hours.

As described above, the solution or gel comprising an inventive composition separates and then traps contaminates from solutions, which causes them to sink. So the minerals, hydrocarbons, ashes, or other substances are separated from sea water. Once contaminates are removed, the remaining water can be processed, via, for example, reverse osmosis to create drinkable water. The contaminate removal is helpful because it avoids damaging treatment systems (e.g., reverse osmosis).

The composition such as Example 6 can also be in a gel or powder form. The powder form can be added to the separated contaminates to solidify them to be rock-like solid. For example, the hydrocarbons become just carbon.

The results with separate treatment with Example 6 and the comparative example are shown in Table 7.

TABLE 7

| | Initial | Treated with | Treated |
|---|---|---|---|
| | sea | polyaluminum | with |
| Parameters | water | chlorohydrate | Example 6 |
| pH | 7.64 | 5.02 | 5.18 |
| Oxygen | 6.28 | 6.56 | 6.29 |
| (mg/L) | | | |
| Chlorides | 9,277 | 8,709 | 9,656 |
| (mg/L) | | | |
| Alkalinity total | 58.1 | <3.64 | <3.64 |
| (mg CaCO₃/L) | | | |
| Ca | 204 | 198 | 216 |
| (mg/L) | | | |
| Turbidity (NTU) | 6.8 | 5.9 | 3.1 |
| Mg | 571 | 533 | 545 |
| (mg/L) | | | |
| Salinity (ppm) | 12.5106 | 12.6825 | 12.5943 |
| Fecal Coliforms | >1600 | 13 | <2 |
| (Fecal Contamination) | | | |
| NMP/100 mL | | | |
| Total Coliforms | >2,420 | 69 | 3 |
| (Bacterias) | | | |
| (NMP/100 mL) | | | |
| Total Suspended | 24.4 | 512 | 32.3 |
| Solids (mg/L) | | | |

The results show that the inventive compositions such as Example 6 have much higher efficiency than the comparative example does. Addition of a charged polysaccharide such as xanthan gum to a coagulant such as polyaluminum chlorohydrate provides surprisingly good results and synergistic effects.

The lab results described above for treatment of leachate, sea water, and hydrocarbon sludge using the inventive composition such as Example 6 were obtained from the samples in which the inventive composition was applied for no more than 36 hours. It is seen in the continuous tests for the example with sea water that with more time, the inventive composition (solution) continues to work up to the point where there appears to be no salt taste in the water without having to use reverse osmosis.

### 2.6. Additional Small-Scale or Large-Scale Trials

In the experiments described herein, unless described otherwise, the waste water or solutions obtained from external sources were brought to the inventor's lab for treatment. When a trial was conducted on a site where contaminated water was obtained, the experimental trials were conducted under the inventor's supervision.

In one exemplary experimental trial, 8,000 liters of leachate was obtained from the Yotoco sanitary landfill plant in Colombia and transferred into in a tank. 80 liters of Example 6 was added into the tank, and the mixture was agitated with a pump, and left to decant for 48 hours. Example 6 and the leachate to be treated was at a ratio of 1:100, and good results were obtained. The mixture was then pumped to another tank and treated with reverse osmosis for better quality.

In one exemplary experimental trial, 80 liters of Pacific Ocean sea water was obtained from Buenaventura, Colombia. 40 liters of sea water was placed in a tank, and mixed with 4 liters of Example 6. Example 6 and sea water to be treated was at a ratio of 1:10. After agitated, the mixture was left to settle for 48 hours. Solids were then removed using a fabric filter, resulting in solids and water suitable for irrigation.

In one exemplary experimental trial, vinasse waste from ethanol production was obtained from Manuelita Sugar Mills in Valle del Cauca, Colombia. In a pilot test, 20 liters of vinasse waster was poured into a tank, and mixed with 4 liters of water, and 2 liters of Example 6 was added. After the mixture was agitated and left still for 5 hours, solids were removed, leaving reddish water, which was not suitable for discharge. Further studies are needed to derive a by-product from both the solid and the treated water.

In one exemplary experimental trial, 18,000 liters of oil water contaminated with emulsified hydrocarbons and solids were obtained from Elogy Plant in Pore, Casanare, Colombia, and then treated with the experimental sample provided in the present disclosure. After the neutral oil water was transferred into a tank, 15 liters of Example 6 were added and homogenized. The ratio of Example 6 to the oil water to be treated is 1:1,200. Within two hours, separation of solids, water, and floating hydrocarbons was observed. Hydrocarbons were removed with a lung pump and solids with a centrifuge, resulting in water suitable for discharge.

Similarly, 500 barrels of oil water were obtained from ATP Engineering Plant in Acacias, Meta, Colombia, and mixed with 30 barrels of water and 60 liters of Example 6. The mixture was agitated and left for 8 days, then processed through a tricanter centrifuge to remove hydrocarbons, water, and solids, yielding good results.

In one exemplary experimental trial, oil sludge wastes were obtained from tank bottoms in Ecoplanta in Aguazul, Casanare, Colombia. 500 barrels of sludge were treated with 50 barrels of water and 60 liters of Example 6. The mixture was heated to 60 degrees Celsius, and processed through a tricanter centrifuge. Solids were removed, and the remaining water and hydrocarbons were further processed to reduce moisture and obtain clean hydrocarbons.

In one exemplary experimental trial, reverse osmosis reject water was obtained from Presidente Sanitary Landfill Plant operated by Veolia, between Buga and Tulua, Valle del Cauca, Colombia. 50 liters of the reverse osmosis reject water, which had a conductivity of 80,000, was mixed with 8 liters of Example 6. The mixture was left still for 15 days and then filtered through silk fabric to remove solids. The conductivity of the water was reduced to 11,000. Heavy metal ions were removed to complying with environmental standards.

In one exemplary experimental trial, waste water was obtained from Occidental Energy Plant in Mulalo, Valle del Cauca, Colombia. 24,000 gallons were treated with 2,000 liters of water and 40 liters of Example 6, agitated with a snail pump for an hour, and heated to 40-50 degrees Celsius for an hour before cooled down. The ratio of Example 6 to the waste water is about 1:2,450. After a week, the mixture was transferred, mixed with additional water and Example 6, agitated again, and left to decant. Solids were removed, and the hydrocarbons were processed to remove moisture, resulting in clean hydrocarbons.

In one exemplary experimental trial, waste water containing cyanide was obtained from a mine. 4 liters of so-called mine water was poured out, and its pH was measured to ascertain neutrality. Subsequently, Example 6 was added to the mixture. An initial observation after 48 hours showed no decantation. However, after extending the duration to 30 days, Example 6 successfully induced decantation. This trial indicates that the decantation process for substances like cyanide-laden mine water is inherently slower.

In one exemplary experimental trial, waste water containing fat was obtained from a meat plant. 20 liters of such a waste water was transferred into a beaker, and Example 6 was then added. The process was monitored, revealing a notably slow progression, as evident by the minimal changes even after 15 days. This outcome suggests that the treatment of fats from processed meat products with Example 6 is a considerably slow process.

### 2.7. Additional Testing Results

Tables 8-12 show additional testing results of the samples such as oil water, leachate, and seawater before and after treatments. In Tables 8-12, polyaluminum chlorohydrate only, which is the control, is referred as “flocculant” and/or “coagulant.” The term “Paragon” used refers to the compositions provided in the present disclosure such as Example 6.

Table 8 shows the data of hydrocarbon sludge before and after the treatments.

TABLE 8

| | | Hydrocarbon | Hydrocarbon | |
|---|---|---|---|---|
| | Hydrocarbon | Sludge with | Sludge with | |
| | Sludge | Flocculant | Paragon | Method |
| Sulfur in crude and products | 1.01 | 1.18 | 0.917 | ASTM D4294 |
| Sediments by extraction | 4.89 | 3.55 | 2.13 | ASTM D473 |
| Micro Carbon Residue | 17.8 | 17.7 | 17.3 | ASTM D4530 |

Table 9 shows the data of leachates before and after the treatments.

TABLE 9

| | | Leachate with | Leachate | |
|---|---|---|---|---|
| | | Flocculant / | with | |
| | Leachate | Coagulant | Paragon | Method |
| Total Alkalinity | 10624 | 9398 | 7049 | SM 2320 B |
| COD Closed | 5564 | 3964 | 3152 | SM 5220 D |
| Reflux (COD | | | | Modified |
| stands for Chemical | | | | |
| Oxygen Demand) | | | | |
| Oils and Fats | 107 | 40.0 | <8.24 | SM 5520 D |
| Ammoniacal | 1747.48 | 2263.52 | 1544.20 | SM 4500- |
| Nitrogen | | | | NH3 B, C |
| Total Suspended | 120 | 140 | 48.0 | SM 2540 D |
| Solids | | | | |
| Turbidity | 160 | 160 | 45 | SM 2130 B |
| Total Coliforms | 3000 | 457000 | 2000 | SM 9223 B |
| Fecal Coliforms | >1600 | >160000 | 1600 | SM 9221 E |
| (Thermotolerant) | | | | |

Table 10 shows the data of seawater before and after the treatments.

TABLE 10

| | | Seawater with | Seawater | |
|---|---|---|---|---|
| | | Flocculant / | with | |
| | Seawater | Coagulant | Paragon | Method |
| Total Alkalinity | 58.1 | <3.64 | <3.64 | SM 2320 B |
| Total Suspended | 24.4 | 512 | 32.3 | SM 2540 D |
| Solids | | | | |
| Turbidity | 6.8 | 5.9 | 3.1 | SM 2130 B |
| Fecal Coliforms | >1600 | 13 | <2 | SM 9221 E |
| (Thermotolerant) | | | | |
| Total Coliforms | >2420 | 69 | 3 | SM 9223 B |

Table 11 shows the conductivity data of reverse osmosis rejection water before and after the treatments. The unit of the conductivity is μs/cm.

TABLE 11

| | Reverse | Reverse Osmosis | Reverse Osmosis | |
|---|---|---|---|---|
| | Osmosis | Rejection with | Rejection with | |
| | Rejection | Paragon 48 hours | Paragon 15 days | Method |
| Electrical Conductivity | 69800 | 37300 | 11390 | SM 2510 B |

Table 12 shows the data of residual fuel oil before and after the treatments.

TABLE 12

| | | Residual | |
|---|---|---|---|
| | Residual | Fuel Oil | |
| | Fuel Oil | with Paragon | Method |
| Total Sulfur Content | 1.14 | 0.263 | ASTM D 4294-21 |
| Calcium | >100 | 0.13 | Flame Atomic |
| | | | Absorption |
| Zinc | >70 | 0.016 | Flame Atomic |
| | | | Absorption |
| Aluminum | >150 | 0.014 | Flame Atomic |
| | | | Absorption |

As shown by the results in all the tables above including Tables 8-12, the composition provided in the present disclosure has high efficacy in treatment. The composition comprising a charged polysaccharide and a coagulant comprising an aluminum-containing compound is much more efficient than the existing coagulants.

Similar to the formulations in Tables 1-2, other ingredients were used to replace xanthan gum. For example, each of the materials including barite, bentonite, caustic soda, glycol, vegetable and organic lubricants, chrome-free tannin and lignite, asphalts, gilsonite, calcium carbonate, graphite, glutaraldehyde-type bactericide were used as an alternative Ingredient A to mix polyaluminum chlorohydrate, and water. The weight of the alternative Ingredient A used varied from 5 grams to 50 grams. The weight of polyaluminum chlorohydrate varied from 1 gram to 14 grams. The weight of water varied in different amounts including 700 grams. The experiments showed that these alternative ingredients did not work. Barite was used for its density. Bentonite was used because of its absorptive properties. Caustic soda was tried for its strong chemical properties. Glycol was tested because of its properties as a solvent. Vegetable and organic lubricants was considered because of its environmental safety. Chrome-free tannin and lignite were used for their natural sourcing. Asphalts and gilsonite were tested because of their binding properties. Calcium carbonate and graphite were tried because of their natural mineral content. Glutaraldehyde-type bactericide was tried because of its antimicrobial properties. However, neither of these materials provide good results including treatment efficacy and/or good formulations.

Although the subject matter has been described in terms of exemplary embodiments, it is not limited thereto. Rather, the appended claims should be construed broadly, to include other variants and embodiments, which may be made by those skilled in the art.

What is claimed is:

1. A composition for treating a water-containing solution or mixture, comprising a charged polysaccharide and a coagulant, wherein the coagulant comprises an aluminum-containing compound, and the charged polysaccharide and the coagulant have a ratio by weight in a range of from 1:20 to 20:1.

2. The composition of claim 1, further comprising water, wherein the charged polysaccharide and the coagulant are present in a range of from 1% to 30% by weight based on a total weight of the composition, and water has a content in a range of from 70% to 99% by weight based on the total weight of the composition.

3. The composition of claim 2, wherein the charged polysaccharide and the coagulant are present in a range of from 1% to 10% by weight based on the total weight of the composition, and water has a content in a range of from 90% to 99% by weight based on the total weight of the composition.

4. The composition of claim 1, wherein the aluminum-containing compound is cationic inorganic oligomer or polymer, and the charged polysaccharide is anionic polysaccharide.

5. The composition of claim 1, wherein the aluminum-containing compound is selected from the group consisting of polyaluminum chloride, aluminum chlorohydrate, polyaluminum chlorohydrate, aluminum sulfate, sodium aluminate, polyaluminum sulfate, polyaluminum silicate chloride, polyaluminum silicate sulfate, and any combination thereof.

6. The composition of claim 1, wherein the aluminum-containing compound is polyaluminum chlorohydrate.

7. The composition of claim 1, wherein the charged polysaccharide is selected from the group consisting of xanthan gum, polyanionic starch, polyanionic cellulose, and alginate.

8. The composition of claim 1, wherein the charged polysaccharide is xanthan gum.

9. The composition of claim 1, wherein the charged polysaccharide and the coagulant have a ratio by weight in a range of from 1:10 to 10:1.

10. The composition of claim 1, wherein the charged polysaccharide and the coagulant have a ratio by weight in a range of from 1:5 to 5:1.

11. The composition of claim 1, wherein the composition contains no surfactant or additive.

12. The composition of claim 1, wherein the composition has a pH value in a range of from 3 to 7.

13. A composition for treating a water-containing solution or mixture, consisting essentially of a charged polysaccharide, a coagulant, and water,
wherein the coagulant comprises an aluminum-containing compound, and the charged polysaccharide and the coagulant have a ratio by weight in a range of from 1:20 to 20:1,
wherein the charged polysaccharide and the coagulant are present in a range of from 1% to 30% by weight based on a total weight of the composition, and water has a content in a range of from 70% to 99% by weight based on the total weight of the composition.

14. The composition of claim 13, wherein the aluminum-containing compound is polyaluminum chlorohydrate, and the charged polysaccharide is xanthan gum.

15. The composition of claim 13, wherein the charged polysaccharide and the coagulant are present in a range of from 1% to 10% by weight based on the total weight of the composition, and water has a content in a range of from 90% to 99% by weight based on the total weight of the composition.

16. The composition of claim 13, wherein the charged polysaccharide and the coagulant have a ratio by weight in a range of from 1:10 to 10:1.

17. The composition of claim 13, wherein the charged polysaccharide and the coagulant have a ratio by weight in a range of from 1:5 to 5:1.

18. A method of making the composition of claim 1, comprising mixing the charged polysaccharide and the coagulant.

19. The method of claim 18, further comprising dissolving the charged polysaccharide and/or the coagulant in water.

20. A method of using the composition of claim 1, comprising: applying the composition into a solution or mixture comprising water and suspended and/or dissolved substances so as to precipitate the suspended and/or dissolved substances and convert the solution or mixture into a clean water.

21. The method of claim 20, wherein the solution or mixture is selected from the group consisting of contaminated water, waste water, sea water, sewage, oil sludge, sugar molasses, and any other mixture thereof in need for treatment.

22. The method of claim 20, further comprising separating a precipitate comprising the suspended and/or dissolved substances from the solution or mixture.

23. The method of claim 20, wherein the method does not include a step of oxidation or reverse osmosis.

24. The method of claim 20, wherein the aluminum-containing compound is polyaluminum chlorohydrate, and the charged polysaccharide is xanthan gum.
